(19) United States
(12) Patent Application Publication
(10) Pub. No.: US 2025/0215737 A1
(43) Pub. Date: Jul. 3, 2025

(54) AUTOMATIC WINDOW APPARATUS OF A VEHICLE, A WINDOW FRAME OF THE SAME, AND A VEHICLE COMPRISING THE SAME

(71) Applicants: HYUNDAI MOTOR COMPANY, Seoul (KR); KIA CORPORATION, Seoul (KR); DAEDONG MOVEL SYSTEM Co., Ltd., Siheung-si (KR)

(72) Inventors: Do Hyun Kim, Hwaseong-si (KR); Myoung Soo Chang, Incheon (KR); Ji Ho Jeong, Siheung-si (KR); Yun Soo Kim, Incheon (KR); Yeong Sik Joo, Siheung-si (KR)

(73) Assignees: HYUNDAI MOTOR COMPANY, Seoul (KR); KIA CORPORATION, Seoul (KR); DAEDONG MOVEL SYSTEM Co., Ltd., Siheung-si (KR)

(21) Appl. No.: 18/967,277

(22) Filed: Dec. 3, 2024

(30) Foreign Application Priority Data
Dec. 29, 2023 (KR) 10-2023-0197443

(51) Int. Cl. E05F 15/689; B60J 1/17; E05D 13/00; E05D 15/16; E05F 15/697

(52) U.S. Cl. CPC E05F 15/6907; B60J 1/17; E05D 13/00; E05D 15/165; E05F 15/6896; E05F 15/697; E05Y 2900/55

(57) ABSTRACT

An automatic window opening and closing apparatus for a vehicle includes a window frame fixed at a body chassis and configured to support a window to slide in a first direction. The automatic window opening and closing apparatus further includes: a guide rail formed on a side surface of the window frame and extending along the first direction, a slider guided and moved by the guide rail while allowing the window to reciprocate in the first direction, and an actuator configured to drive the slider.

### CROSS-REFERENCE TO RELATED APPLICATION

This application claims priority to Korean Patent Application No. 10-2023-0197443, filed on Dec. 29, 2023, the entire contents of which are incorporated herein by reference.

### TECHNICAL FIELD

The present disclosure relates to an automatic opening and closing apparatus for glass window of a vehicle, and more particularly, to an automatic opening and closing apparatus of vehicle glass window that automatically opens and closes a window of a driver seat of a bus.

### BACKGROUND

In an automatic opening and closing window of a driver seat for a small and medium-sized bus, as illustrated in FIGS. 1-2A, a moving carriage 15 may move along a carriage rail 14 when the driving force of a motor 10 is reduced by a reducer 11 and a screw wire 13 is driven through a screw wire driving unit 12.

When the moving carriage 15 moves along the carriage rail 14, a window opening and closing bracket 17 may be guided by a bracket guide member 18 to allow a window 1 slide left and right to open and close the window.

In the automatic opening and closing window, a hanger plate 16 may be attached to a body chassis 3, and the carriage rail 14 may be fixed to the hanger plate. When the movement trajectory of the moving carriage 15 along the carriage rail 14 corresponds to the movement trajectory of the opening and closing window 1 of a lower window frame 2, as shown in FIG. 2B, smooth opening and closing of the opening and closing window 1 may be possible.

However, as shown in FIG. 2C, when the lower window frame 2 and the carriage rail 14 separately placed on the body chassis 3 are not parallel to each other due to the assembly tolerance of components, the movement trajectory of the moving carriage 15 along the carriage rail 14 may not correspond to the movement trajectory of the opening and closing window 1 of the window frame 2, thereby generating noise during opening and closing and causing the overload of the motor 10.

The statements in this section merely provide background information related to the present disclosure and may not constitute prior art.

### SUMMARY

The present disclosure provides an automatic opening and closing apparatus of a vehicle window configured to match the movement trajectory of a slider of a guide rail and the movement trajectory of the opening and closing window of a lower window frame on a rail carriage by using a window frame in which the guide rail is formed integrally.

According to an embodiment of the present disclosure, there is provided an automatic window apparatus for a vehicle. The automatic window apparatus includes: a window frame configured to support a window to slide in a first direction, a guide rail formed on a side surface of the window frame and extending along the first direction, a window sliding member configured to move the window backward and forward along the first direction while being guided by the guide rail, and an actuator configured to drive the window sliding member.

The window frame and the guide rail may be integrally formed by extrusion molding.

The window sliding member may include a slider guided by the guide rail to slide, and a connection bracket configured to connect the slider to the window such that the window moves together with the slider.

The actuator may be coupled with the slider and includes a driving belt extended in the first direction.

The actuator may include a driving pulley and a driven pulley spaced apart from each other in the first direction to drive the driving belt.

The actuator may further include a motor, a worm rotated by the motor, a worm wheel engaged with the worm, a reducer configured to reduce a speed of rotation of the worm wheel to transmit a force to the driving pulley.

The motor may include a rotational shaft extending in a same direction as an extension direction of a vertical frame of the window frame.

The window frame may further include an extension bracket extended in the first direction from the vertical frame.

The reducer may be placed on the extension bracket.

According to an embodiment of the present disclosure, there is provided a window frame for a vehicle automatic window apparatus. The window frame includes a frame configured to support a bottom of a window to slide in a first direction, and a guide rail formed on a side surface of the frame and extending along the first direction.

The frame and the guide rail may be integrally formed by extrusion molding.

The window frame may further include a vertical frame extending in a direction vertical to the first direction, and an extension bracket extending in the first direction from the vertical frame and including a reducer.

According to an embodiment of the present disclosure, there is provided a vehicle including an automatic window apparatus. The automatic window apparatus includes a window frame fixed to a vehicle body and including a window rail for supporting a bottom of a window to slide in a first direction, a guide rail formed on a side surface of the window rail and extending in the first direction, a window sliding member configured to move the window backward and forward along the first direction while being guided by the guide rail, and an actuator configured to drive the window sliding member to reciprocate.

The window frame and the guide rail may be integrally formed by extrusion molding.

The window sliding member may include: a slider configured to be driven by the actuator and guided by the guide rail, and a connection bracket configured to connect the slider to the window such that the window moves together with the slider.

The actuator may include a driving belt which is coupled with the slider and configured to extend in the first direction.

The actuator may include a driving pulley and a driven pulley. The driving pulley and the driven pulley are spaced apart from each other in the first direction, and the driving pulley is configured to drive the driving belt.

The actuator may further include a motor, a worm rotated by the motor, a worm wheel engaged with the worm, a reducer configured to reduce a rotation speed of the worm wheel and transmit a force to the driving pulley.

The motor may include a rotational shaft extending in a same direction as an extension direction of a vertical frame of the window frame.

The window frame may further include an extension bracket extended in the first direction from the vertical frame.

The reducer may be placed on the extension bracket.

An automatic window opening and closing apparatus for a bus according to the present disclosure precisely matches the moving trajectory by forming the guide rail and the lower window frame in an integrated form, thereby preventing noise and motor overload while the window moves, and provides substantial and practical effects such as improving durability, minimizing the number of components, simplifying the operating structure, implementing weight reduction, etc.

### BRIEF DESCRIPTION OF DRAWINGS

FIG. 1 and FIG. 2A are views illustrating an automatic opening and closing window of a driver seat of a bus in the related art.

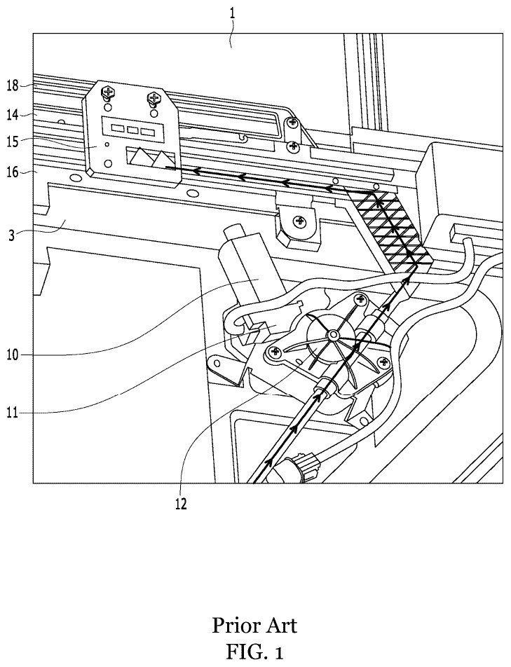

FIGS. 2B and 2C are views respectively illustrating a movement trajectory of a moving carriage of the automatic opening and closing window in the related art.

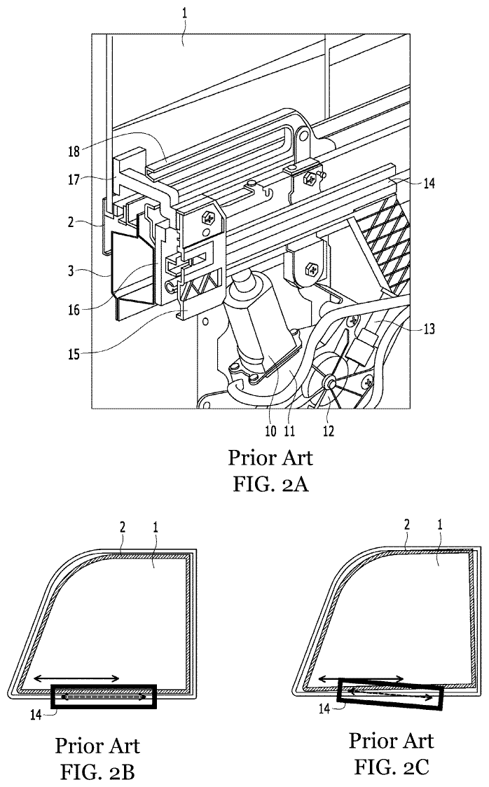

FIG. 3 is a view illustrating an automatic window opening and closing apparatus for a bus according to an embodiment.

FIG. 4 is a partial enlarged view of FIG. 3.

FIG. 5 is a view illustrating a connection of a window sliding member to a window and a guide rail according to an embodiment.

FIG. 6 is a partial cross section view of the automatic window opening and closing apparatus shown in FIG. 3.

### DETAILED DESCRIPTION

While embodiments are described with reference to the accompanying drawings, it should be understood that various changes and modifications may be made in the present disclosure. Further, it should be understood that the present disclosure is not limited to the specific embodiments thereof, and various changes, equivalences, and substitutions may be made without departing from the scope and spirit of the present disclosure.

In the embodiments of the present disclosure, terms such as “module”, “unit”, “part”, and the like are terms used for nominal distinct between components, and it should not be interpreted as assuming that they are physically and chemically separated or capable of being separated or divided.

Terms containing ordinal numbers, such as “first”, “second”, etc., may be used to describe various components, but the components are not limited by the terms. These terms may be used only in a nominal sense to differentiate one component from another component, and their mutual sequential meaning should be understood through the context of the corresponding description, not through such terms.

The term “and/or” is used to include all instances of any combination of multiple items being the subject. For example, “A and/or B” includes all three cases: “A”, “B”, and “A and B”. When a component, device, element, or the like of the present disclosure is described as having a purpose or performing an operation, function, or the like, the component, device, or element should be considered herein as being “configured to” meet that purpose or to perform that operation or function.

When a component is used to be “coupled” or “connected” to another component, it should be understood that the component may be either connected directly to another component, or connected indirectly via another medium.

The terms in the present disclosure are used to describe an embodiment and do not intend to restrict and/or limit the present disclosure. Singular forms are intended to include plural forms unless the context clearly indicates otherwise. According to an embodiment of the present disclosure, terms such as “comprise” or “consist of” are used to designate presence of characteristics, numbers, steps, operations, elements, components or a combination thereof, and do not foreclose the presence or possibility of addition of one or more other characteristics, numbers, steps, operations, elements, components or a combination thereof.

Unless otherwise defined, all terms used in the embodiment of the present disclosure including technical or scientific terms, have the same meaning as generally understood by an ordinary person skilled in the technical field to which the present disclosure pertains. Terms defined in commonly used dictionaries should be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” are only widely used for names of devices that control the corresponding functions, and are not construed as being generic functional units. For example, devices using the terms may include a communication device that communicates with another controller or sensor to control the corresponding function, a computer-readable recording media that stores operating systems, logic commands, input/output information, etc., and at least one or more of processor that performs determination, calculation, decision, etc. used to control the corresponding function.

A processor may include a semiconductor integrated circuit and/or electronic elements that perform at least one or more of comparison, determination, calculation, and decision to achieve a programmed function. For example, the processor may be one or the combination of a computer, a microprocessor, a CPU, an ASIC, and electronic circuits (circuitry, logic circuits).

A computer-readable recording medium (or referred to as memory) includes all types of storage devices that store data that is read by a computer system. Examples of the computer-readable recording medium may include at least one a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, and an optical disk type.

Such recording medium may be electrically connected to the processor, and the processor may load and record data from the recording medium. The recording medium and processor may be integrated or may be physically separated.

An embodiment of the present disclosure is explained with reference to the drawings.

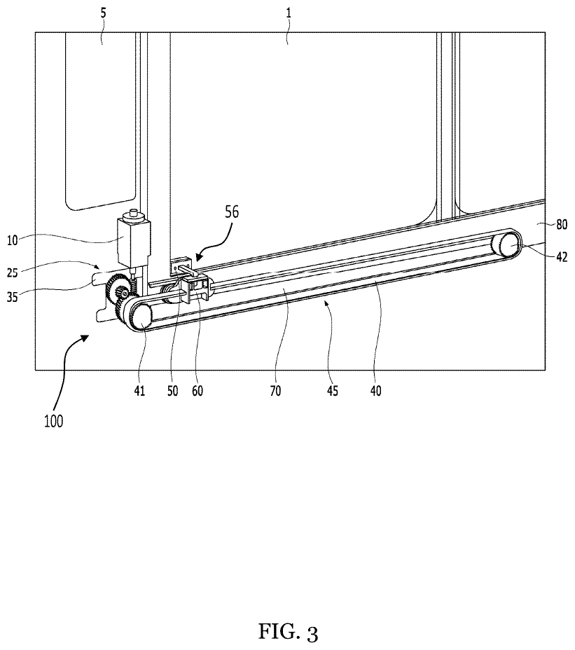

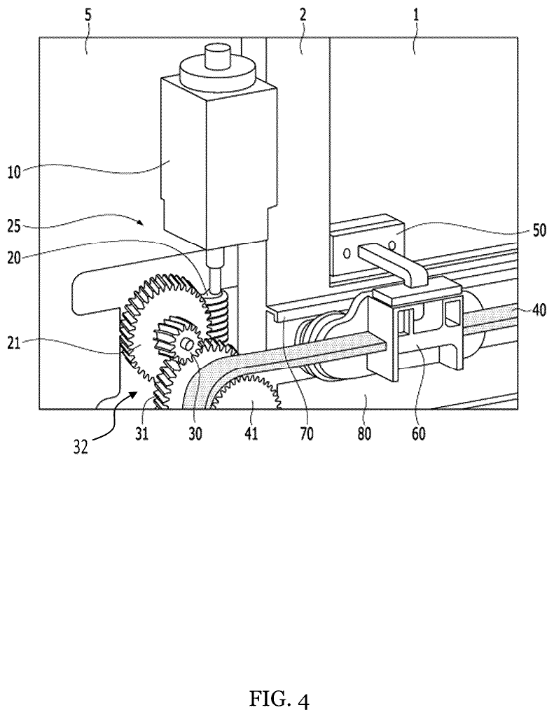

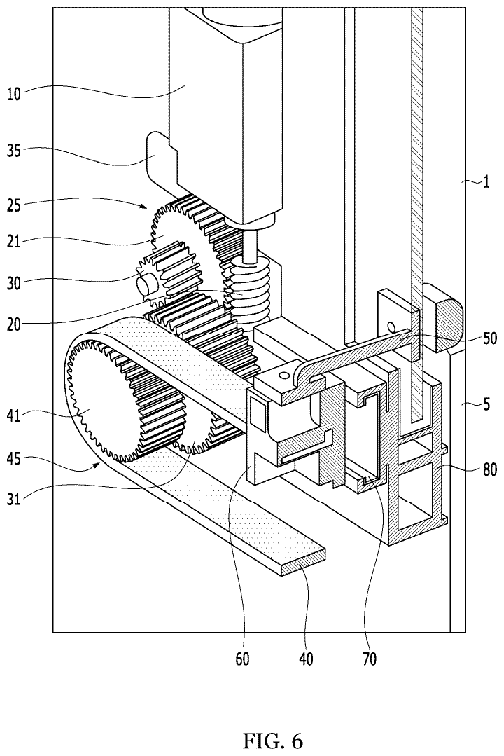

According to one embodiment of the present disclosure, as shown in FIG. 3 to FIG. 6, an automatic window opening and closing apparatus for a bus may include a window frame 80 of a window 1 which is closed or opened, and the window frame 80 is formed integrally with a guide rail 70.

The window frame 80 supports the lower part of the window 1, and the guide rail 70 may be formed integrally on the front surface of the window frame 80 by extrusion molding so that the movement trajectories of the window frame 80 and the guide rail 70 may be precisely aligned with each other.

A window sliding member 56 may be coupled to the guide rail 70 of the window frame 80, and the window sliding member 56 may include a slider 60 and a connection bracket 50.

The slider 60 may be fitted into the guide rail 70 of the window frame 80, and the slider 60 may be attached to the window 1 by the connection bracket 50.

When the slider 60 moves along the guide rail 70, the window 1 may move along the window frame 80. The window frame 80 and the guide rail 70 may be integrally formed through extrusion molding, so that the movement trajectory of the window 1 and the movement trajectory of the slider 60 may be exactly aligned while opening and closing the window 1.

The actuator 100 may include a driving belt which is coupled with the slider 60 and extending in the first direction. The slider 60 may be moved by the driving belt 40. The actuator 100 further includes a driving pulley 41 and a driven pulley 42.

The driving pulley 41 may receive power while sharing the same shaft as the reduction driven shaft 31, and the reduction driven shaft 31 may be engaged with a reduction driving shaft 30 to facilitate deceleration.

The actuator 100 further includes: a motor 10, a worm 20 rotated by the motor, a worm wheel 21 engaged with the worm, and a reducer 32 configured to reduce a rotation speed of the worm wheel and transmit a driving force to the driving pulley. The reduction driving shaft 30 may receive a driving force while sharing the same shaft as a worm wheel 21, the worm wheel 21 may be engaged with a worm 20, and the worm 20 may be configured to be driven by the motor 10.

When the motor 10 fixedly attached to the side window frame of the window 1 is driven, the worm 20 may drive the worm wheel 21, the speed may be reduced by the reduction driving shaft 30 and the reduction driven shaft 31 and the force may be transmitted to the driving pulley 41 to drive the driving belt 40.

The worm wheel 21 may be supported by an extension bracket 35 fixedly attached to the side window frame of the window 1, and the driving pulley 41 and the driven pulley 42 may be provided on the window frame 80.

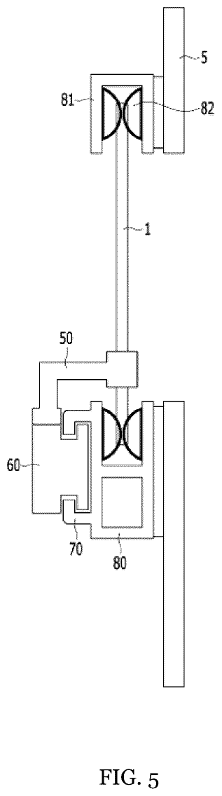

According to an embodiment, the automatic window opening and closing apparatus for a vehicle (e.g., a bus) may be configured so that an upper window frame 81 and the window frame 80 of the window 1 may be bonded to a fixed window 5 by an adhesive sealer as shown in FIG. 5.

The window 1 may be fitted to the upper window frame 81 and the window frame 80 using a sealing rubber 82, and configured to slide along the upper window frame 81 and the window frame 80 while sealing is performed by the sealing rubber 82.

Since the opening guide rail 70 may be formed integrally with the window frame 80 by extrusion molding, components such as the carriage rail 14, the hanger plate 16, and the bracket guide member 18 may be omitted.

The structure may be simplified and light-weighted by integrally forming the opening guide rail 70 and the window frame 80.

The actuator 100 may be implemented to transmit the driving force of the motor 10 to the driving pulley 41, and when the worm 20 forming the driving shaft of the motor 10 operates the worm wheel 21, the driving force may be reduced by the reducer 32 and transmitted to the driving pulley 41. The reducer 32 includes the reduction driving shaft 30 and a reduction driven shaft 31.

In the actuator 100, the driving belt 40 may be coupled to the slider 60, and both sides of the driving belt may be wound around the driving pulley 41 and the driven pulley 42. When the driving pulley 41 is driven at a reduced speed by the reducer 32, the driving belt may be driven to move the slider 60 along the guide rail 70.

As described above, some embodiments according to the present disclosure have been described, and it is obvious to those having ordinary skill in the art that the present disclosure can be embodied in other specific forms in addition to the embodiments described above without departing from the spirit or scope thereof. Therefore, the above-described embodiments should be considered as illustrative rather than restrictive, and accordingly, the present disclosure is not limited to the above description, but may be modified within the scope of the appended claims and their equivalents.

Although the above description focuses on specific embodiments, they do not limit the present disclosure. Those having ordinary skill in the art should understand that various variations and applications are possible without departing from the technical concepts of the present disclosure. For example, in the embodiments, each component may be modified and implemented. The variations and differences in application should be construed as being included in the scope of the present disclosure as defined in the appended claims.

### DESCRIPTION OF NOTATIONS

1: Motor
20: Worm
21: Worm Wheel
30: Reduction Driving Shaft
31: Reduction Driven Shaft
35: Extension Bracket
40: Driving Belt
41: Driving Pulley
42: Driven Pulley
50: Connection Bracket
60: Slider
70: Guide Rail
80: Window Frame

What is claimed is:

1. An automatic window apparatus of a vehicle, the automatic window apparatus comprising:
a window frame configured to support a window to slide in a first direction;
a guide rail formed on a side surface of the window frame and extending along the first direction;
a window sliding member configured to move the window backward and forward along the first direction while being guided by the guide rail; and
an actuator configured to drive the window sliding member.

2. The automatic window apparatus of claim 1, wherein the window frame and the guide rail are integrally formed by extrusion molding.

3. The automatic window apparatus of claim 1, wherein the window sliding member comprises:
a slider guided by the guide rail; and
a connection bracket configured to connect the slider to the window such that the window moves together with the slider.

4. The automatic window apparatus of claim 3, wherein the actuator is coupled with the slider and includes a driving belt extended in the first direction.

5. The automatic window apparatus of claim 4, wherein the actuator includes a driving pulley and a driven pulley spaced apart from each other in the first direction to drive the driving belt.

6. The automatic window apparatus of claim 5, wherein the actuator further comprises,
a motor, a worm rotated by the motor, a worm wheel engaged with the worm, and a reducer configured to reduce a speed of rotation of the worm wheel to transmit a driving force to the driving pulley.

7. The automatic window apparatus of claim 6, wherein the motor includes a rotational shaft extending in a same direction as an extension direction of a vertical frame of the window frame.

8. The automatic window apparatus of claim 7, wherein the window frame further comprises an extension bracket extended in the first direction from the vertical frame, and
wherein the reducer is placed on the extension bracket.

9. A window frame for an automatic window apparatus of a vehicle, the window frame comprising:
a frame configured to support a bottom of a window to slide in a first direction; and
a guide rail formed on a side surface of the frame and extending along the first direction.

10. The window frame of claim 9, wherein the frame and the guide rail are integrally formed by extrusion molding.

11. The window frame of claim 9, further comprising:
a vertical frame extending in a direction vertical to the first direction; and
an extension bracket extending in the first direction from the vertical frame and including a reducer.

12. A vehicle including an automatic window apparatus,
wherein the automatic window apparatus comprises:
a window frame fixed to a vehicle body and including a window rail for supporting a bottom of a window to slide in a first direction;
a guide rail formed on a side surface of the window rail and extending in the first direction;
a window sliding member configured to move the window backward and forward along the first direction while being guided by the guide rail; and
an actuator configured to drive the window sliding member to reciprocate.

13. The vehicle of claim 12, wherein the window frame and the guide rail are integrally formed by extrusion molding.

14. The vehicle of claim 12, wherein the window sliding member comprises,
a slider configured to be driven by the actuator and guided by the guide rail, and
a connection bracket configured to connect the slider to the window such that the window moves together with the slider.

15. The vehicle of claim 14, wherein the actuator comprises a driving belt which is coupled with the slider and extending in the first direction.

16. The vehicle of claim 15, wherein the actuator further includes a driving pulley and a driven pulley, and
wherein the driving pulley and the driven pulley are spaced apart from each other in the first direction, and the driving pulley is configured to drive the driving belt.

17. The vehicle of claim 16, wherein the actuator further comprises,
a motor, a worm rotated by the motor, a worm wheel engaged with the worm, and a reducer configured to reduce a rotation speed of the worm wheel and transmit a driving force to the driving pulley.

18. The vehicle of claim 17, wherein the motor includes a rotational shaft extending in a same direction as an extension direction of a vertical frame of the window frame.

19. The vehicle of claim 18, wherein the window frame further comprises an extension bracket extended in the first direction from the vertical frame, and wherein the reducer is placed on the extension bracket.
